(19) United States
(12) Patent Application Publication
(10) Pub. No.: US 2012/0170559 A1
(43) Pub. Date: Jul. 5, 2012

(54) METHOD AND SYSTEM FOR OUT-OF-BAND DELIVERY OF WIRELESS NETWORK CREDENTIALS

(76) Inventors: Eugene M. Feinberg, Sunnyvale, CA (US); Berend Ozceri, Sunnyvale, CA (US); Bruce Smith, Livermore, CA (US); Yuval Koren, San Francisco, CA (US)

(21) Appl. No.: 12/985,264

(22) Filed: Jan. 5, 2011

(51) Int. Cl. H04W 84/02

(52) U.S. Cl. 370/338

(57) ABSTRACT

At a server, a user account established by a user of an AP hosting device is associated with information sufficient to permit a CLIENT to join a WLAN of which the AP is a part. The CLIENT is provided, via an OOB network different from the WLAN, the information sufficient to permit the CLIENT to join the WLAN of which the AP is a part, which information may include a unique identifier for the AP hosting device and information indicative of a network key for the WLAN (e.g., a secret key associated with the AP hosting device, a network key for the WLAN, or information that permits generation of the network key for the WLAN). Thereafter, the CLIENT may use the subject information to join the WLAN of which the AP is a part.

### FIELD OF THE INVENTION

The present invention relates to methods and systems for out-of-band delivery of wireless network credentials to a device.

### BACKGROUND

Wireless local area networks (WLANs), such as those based on the Institute for Electrical and Electronic Engineers (IEEE) 802.11a/b/g/n standards, are today ubiquitous in business, government and small office/home office (SOHO) settings. Unlike their wired LAN counterparts, WLANs provide for communication among network elements through wireless transmissions (e.g., radio transmissions), as opposed to wired, physical connections. In 802.11-based WLANs, clients or “stations” (i.e., computers or mobile devices with wireless network interfaces) often interact with other network devices (printers, file servers, other clients, etc.) through access points (APs), which act as interfaces between wired and wireless networks. In some cases, wireless clients may communicate directly with one another, without the use of APs (e.g., using so-called adhoc networks established between the wireless clients or when operating in Wi-Fi Direct mode).

Security in IEEE 802.11-based networks is provided by an authentication service and an optional encryption protocol known as WEP (wired equivalent privacy). WEP is a link-layer security protocol in which the same cipher key is used for both encryption and decryption. WEP was intended to provide confidentiality for wireless communications, through the use of encryption; access control for a network, through the option to discard improperly encrypted packets; and data integrity, through the use of a checksum. Unfortunately, however, WEP has been shown to have fundamental flaws (including flaws that allow hackers to uncover the actual cipher keys) that can be exploited to allow unauthorized clients to gain access to an 802.11-based WLAN and so has largely been supplanted by WPA (Wi-Fi Protected Access). Among other things, WPA replaces the static, 40-bit encryption keys used by WEP with dynamic, 128-bit per-packet keys.

The cipher keys used in WEP and WPA are examples of pre-shared keys (PSKs). As indicated, in Wi-Fi systems (i.e., those conforming with the above-referenced IEEE standards) that do not rely on advanced security measures, the same PSK is used by an AP and all wireless clients of that AP. In addition to the appropriate PSK, a network identifier (termed “SSID” or service set identification) must also be used by the client and the AP to identify the network of which each are a part. SSIDs are broadcast by APs to alert potential clients to their presence.

In U.S. Pat. No. 7,551,577, incorporated herein by reference, a system and method for provisioning WLAN AP information on a wireless dual mode device (DMD) by leveraging an out of band network are described. Responsive to a triggered event, or at a specified time, the DMD, which includes a Wi-Fi transceiver and a cellular data network transceiver, contacts a server via the out of band (OOB) network and obtains AP information for various APs (e.g., those maintained by the carrier that provides the out of band network). This allows the DMD to access the Internet via one of the designated APs instead of via the OOB network.,

### SUMMARY OF THE INVENTION

In one embodiment, the present invention facilitates association of a user account established by a user of an AP hosting device with information sufficient to permit a client device to join a WLAN of which an AP hosted by the AP hosting device is a part. In particular, the client device is provided, via an OOB network different from the WLAN (e.g., a separate WLAN, a cellular data network or other radio frequency network, an Ethernet network, or another communication network), AP information sufficient to permit the client device to join the WLAN of which the AP is a part. In some instances, the information sufficient to permit the client device to join the WLAN of which the AP is a part may be a unique identifier for the AP hosting device (e.g., a media access control (MAC) address or BSSID) and information indicative of a network key for the subject WLAN (e.g., a secret key associated with the AP hosting device, a network key for the subject WLAN, or information that permits generation of the network key for the subject WLAN).

In further embodiments, the present invention may be instantiated as a system that includes a server configured to associate a user account established by a user of an AP hosting device with information sufficient to permit a client device to join a WLAN of which an AP hosted by the AP hosting device is a part, and to provide that information to the client device via an OOB network different from the WLAN; and an AP hosting device configured to establish the WLAN with configuration parameters that accommodate the use of the information provided to the client device. In such a system, the information sufficient to permit the client device to join the WLAN of which the AP is a part may include a unique identifier for the AP hosting device and information indicative of a network key for the WLAN (for example, a secret key associated with the AP hosting device, a network key for the WLAN, or information that permits generation of the network key for the WLAN).

In any of the embodiments described herein, the information concerning the subject AP hosting device and/or WLAN may be provided to the client device in response to a request therefor, or may be pushed to the client device. Alternatively, the information may be provided upon a successful log in to the user account without having to make a separate request therefor. Such a log in may be initiated upon successful installation of an application to a smart phone or similar device and provisioning of the application with the user account credentials. Alternatively, or in addition, the log in may be initiated in response to a user action, such as an indication for the log in process to be initiated via the smart phone application or other means. In addition to information concerning the subject WLAN, the server may provide information concerning other AP hosting devices and/or respective WLANs associated with the user account.

Still further embodiments of the present invention provide a method in which a user account having user account credentials and being associated with information sufficient to permit a client device to join a WLAN of which an AP is a part, is established at a server. When the user account credentials are presented, for example via a client device, the server provides a client device, via an OOB network different from the WLAN of which the subject AP is a part, the information sufficient to permit the client device to join that subject WLAN. In some instances, the server may furthr provide information concerning other WLANs and/or AP hoisting devices associated with the user account. At any time after the information has been provided, the client device may subsequently join the WLAN according to configuration parameters based on the received information.

In this method, the information sufficient to permit the client device to join the WLAN of which the AP is a part may be information that permits generation of a network key for the WLAN and/or may include a unique identifier for a device hosting the AP. Alternatively or in addition, the information may be indicative of a network key for the WLAN, for example a secret key associated with the AP hosting device, or the actual network key for the WLAN. These and further embodiments of the invention are described in greater detail below.

### BRIEF DESCRIPTION OF THE DRAWINGS

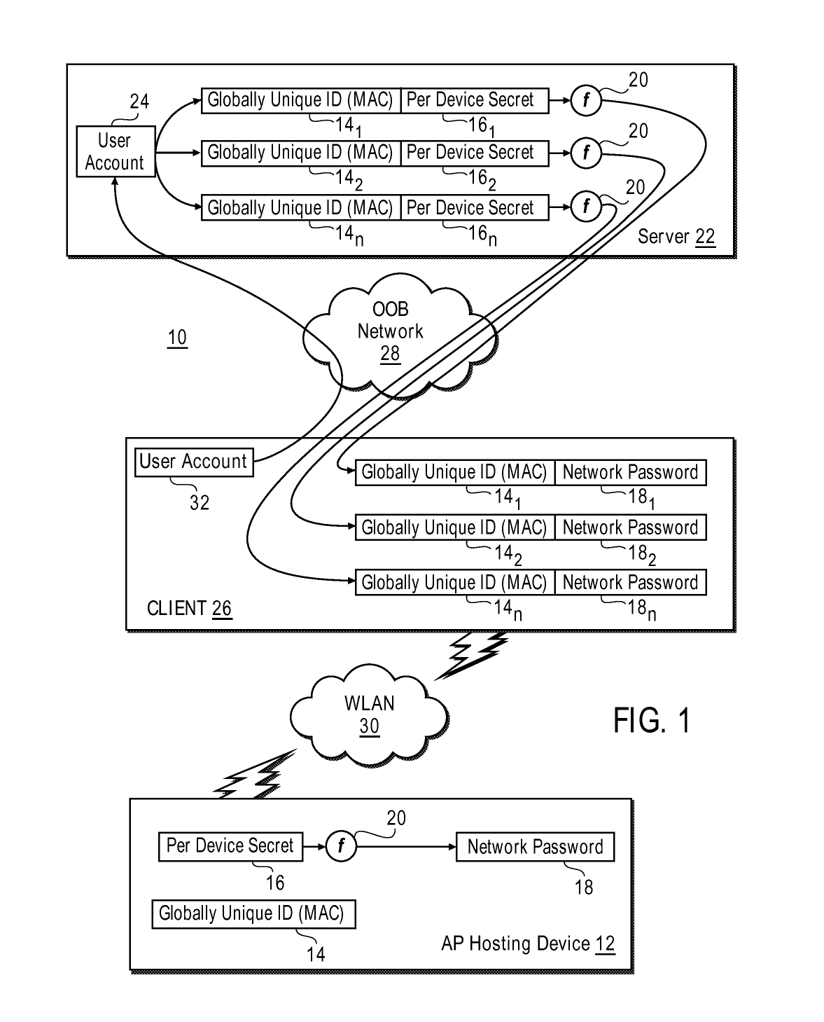

The present invention is illustrated by way of example, and not limitation, in the accompanying drawings, in which FIG. 1 illustrates a system in which embodiments of the present invention operate and are instantiated.

### DETAILED DESCRIPTION

Described herein are methods and systems for OOB delivery of wireless network credentials to a device, for example a mobile phone, portable or other computer system, personal digital assistant, tablet computer or other device (a “CLIENT”). In one embodiment of the present invention, an AP hosting device is configured with a PSK (or information that permits generation of a PSK) at the time of its manufacture, and that PSK (or other information) is stored in association with identifying information for the AP hosting device in a network accessible storage device. For example, the PSK (or other information) may be stored in association with a media access control (MAC) address or other unique identifier for the AP hosting device in the network accessible storage device. This PSK/MAC address pairing may be stored as or later associated with a user account established by the owner/user of the AP hosting device and subsequently provided to a CLIENT via an OOB network (e.g., a separate WLAN, a cellular data network or other radio frequency network, an Ethernet network, or another communication network), in some cases responsive to the presentation of the user account credentials. The CLIENT may thereafter use the PSK/MAC address pair to contact the AP hosting device via a WLAN that uses the PSK/MAC address configuration information.

Before describing aspects of the present invention in further detail, it is helpful to define certain terms. As used in connection with describing the present invention, the term CLIENT is intended to refer to a device, often a portable device, that is configured for communication over at least a WLAN configured in accordance with the above-referenced IEEE 802.11 wireless networking standards, and often, but not necessarily, over a separate communications network, for example a cellular data network, such as the various 2G/3G/4G networks in use today, a Bluetooth or other radio frequency network, an Ethernet network, or another communications network. Examples of CLIENTs include smart phones, personal digital assistants, laptop or other computers, tablet computers, netbooks, and similar devices. The term AP is intended to refer to a WLAN access point configured to communicate using a WLAN protocol, such as protocols specified by the IEEE 802.11 wireless networking standards. An AP hosting device is a device that includes a WLAN AP, and in some embodiments may be instantiated as a removable media card or embedded module for a digital imaging device such as a digital still camera. The term “out of band” (OOB) refers to a communication network other than a subject WLAN of which an AP hosted by an AP hosting device is a part. Note therefore that OOB networks may include WLANs that do not include a subject AP. By network accessible storage device, we mean a storage device accessible via the OOB network, for example through communication with a server hosting a user account.

In order to better understand the present invention, it is helpful to have a use scenario in mind. One typical (though not exclusive) use scenario involves a removable media card of the kind described in U.S. Pat. No. 7,702,821, assigned to the assignee of the present invention and incorporated herein by reference. Such a media card may be a digital media storage device having a housing sized and configured to be accommodated within a digital camera host, a host interface for receiving digital image information from the digital camera host, a wireless communication interface, a controller coupled to the host interface and the wireless communication interface, and a memory communicatively coupled to the controller for storing the digital image information. In other embodiments, the functionality provided by a media card of this type may be embodied as a module of a digital camera host that is not removable therefrom. That is, the module may be embedded (as firmware and/or hardware) within the host camera. Insofar as the discussion herein shall be directed to removable media card embodiments, it shall apply equally to embedded module embodiments.

The wireless communication interface of the subject media card preferably includes a wireless transceiver that operates in accordance with the above-referenced IEEE 802.11 wireless networking standards. Consequently, the media card is capable of operating as an AP for an 802.11-compliant WLAN, and so is an example of an AP hosting device. This is useful for the present use scenario inasmuch as a client device may connect to the AP hosted by the media card and upload digital images stored by the media card without need for any additional network infrastructure. Thus, images captured by the host camera may be transferred to computer systems, smart phone, tablet computers and the like, directly using the AP of the media card.

While it may be that some users would be agreeable to the notion of anyone with a Wi-Fi client being capable of uploading digital images from the user's media card, most users likely would object to such a situation. Therefore, in order to prevent unauthorized access to a user's media card-established WLAN, that WLAN is protected by a PSK. The task then is to provide the user's client devices with the PSK without having the user have to memorize complicated pass phrases or network keys, or otherwise manually configure the client device(s) for such operation.

To facilitate the automated transfer of PSK (and perhaps other) information to the client device, a server at which the user can establish a user account is provided. The user account may be established automatically as part of a device registration process, for example when the user registers his/her media card, activates warranty protection for the media card, or otherwise activates the account. Associated with the user account will be information sufficient to permit a user's client device(s) to join a WLAN established by the media card AP.

To access the account, the user is provided an application to be installed on the client device. This may be an application for a smart phone, personal digital assistant, tablet computer or other computer device. The application facilitates communication between the client device and the server (or an application running on the server) via an OOB network, and if configured with stored versions of the user account credentials (e.g., a user name and password) may automatically present those credentials in order to log in the user to the account. Once logged in, the information sufficient to permit a user's client device(s) to join a WLAN established by the media card AP may be automatically downloaded to the client device (e.g., in some cases after receiving user authorization to do so or in other cases without the need for any user intervention). In addition, similar information concerning other media cards (or any other APs) associated with the same user account may also be downloaded. For example, users may permit friends and family to use their APs by providing permission for such information to be associated with accounts of friends and family and thereafter provided to client devices of friends and family in the manner discussed herein.

Sometime after the information sufficient to permit a user's client device(s) to join a WLAN established by the media card AP has been downloaded to the client device, when the client device observes a WLAN (e.g., by receiving an SSID of a WLAN), the identifying information for the WLAN is checked against the WLAN information provided by the server. lithe identifying information indicates that this WLAN is one for which the client device has network credentials (e.g., an appropriate PSK), the client device may join the WLAN without need for any user intervention (although in some cases user's may be queried to determine whether joining the WLAN is desired/approved). Once the WLAN has been joined, the transfer of digital images from the media card to the client device via the WLAN may proceed (again, with out without user intervention), without need for any further OOB communications, etc.

The foregoing is but one example of a use for the present invention, now described in a more general fashion with reference to FIG. 1, which illustrates a system 10 in which embodiments of the present invention operate and are instantiated. The system includes AP hosting device 12, which is configured to operate a WLAN AP, for example one that operates according to protocols specified by the IEEE 802.11 wireless networking standards. As indicated above, in one particular embodiment AP hosting device 12 is a content-aware digital media storage device of the kind described in U.S. Pat. No. 7,702,821.

At the time of its manufacture, AP hosting device 12 is associated with a MAC address or other globally unique identifier 14, which is stored in hardware or firmware. As the designator implies, this identifier uniquely differentiates one AP hosting device 12 from another, and in the case of a MAC address from any other network-capable device. The AP hosting device 12 is also associated with a secret key 16, which is also unique to the device. The secret key 16 is not itself a network key (i.e. a PSK), but it can be used to generate such a network key. Hence, in some instances the AP hosting device 12 may be configured to generate a network key 18 by applying the secret key 16 to a function 20 (e.g., implemented by a controller or other processor executing appropriate controller-executable instructions stored thereon or by dedicated circuitry, to generate the network key (also known as a network password), which is then stored in the AP hosting device 12. Alternatively, the network key (rather than the secret key) may be created and stored on the AP hosting device 12 at the time of its manufacture.

Also shown in FIG. 1 is a server 22. Server 22 may be provided by the manufacturer/distributor of the AP hosting device 12, or may be provided by a third party (e.g., a photo finishing service provider, a camera manufacturer/distributor, or another party). Server 22 provides facilities for the owner of AP hosting device 12 to create a user account 24. The account may provide the user with a number of services and, of interest to the present invention, allows the user to associate the MAC address (or other unique identifier) of the AP hosting device 12 with the account. If the user has multiple AP hosting devices, he/she may so associate the MAC addresses, 14₁, 14₂, . . . , 14ₙ, of those devices with a single user account 24. Once these bindings are established, the associated secret keys, 16₁, 16₂, . . . , 16ₙ, of the cards may be automatically associated with the user's account according to information maintained by the manufacturer of the media cards. In addition, friends and family members of the user may be designated (e.g., by email address or other means) so that these friends and family members may later be provided information that allows their respective client devices to join a WLAN that includes an AP hosted by the AP hosting device 12.

As an example, the manufacturer of the AP hosting device may establish a single database of MAC addresses and secret keys, or separate but linked (e.g., related) databases of same, and make the database(s) accessible to an application running on server 22. When the user obtains an AP hosting device and executes a registration process, for example, by connecting the device to a personal computer and executing a registration application stored on the device or accessible via the Internet, the account 24 is established for the user. As part of the registration process, the AP hosting device may provide the server with its MAC address (or other identifier) and the server may compare that MAC address (or other identifier) with the stored information provided by the manufacturer to obtain the secret key associated with the AP hosting device. Alternatively, both the MAC address and the secret key may be uploaded from the AP hosting device as part of the registration process, without the need for pre-established databases.

Some time after the user account 24 has been established (e.g., complete with some associated user credentials, such as a user name and password, to safeguard the account), the user may use CLIENT 26 to contact server 22 via the out of band network 28 and log in to the account using user account credentials 32 presented via the CLIENT. This may involve launching a dedicated application on CLIENT 26 to initiate the contact with server 22 via OOB network 28, or the user may contact the server through the use of a Web browser or messaging client running on CLIENT 26. OOB network 28 may be a cellular data network or other network (e.g., a WLAN, a Bluetooth network, an Ethernet network, etc.).

Upon successful presentation of the user account credentials, the server 22 may return the MAC address(es) (or other unique identifiers) 14₁, 14₂, . . . , 14ₙ, and network passwords 18₁, 18₂, . . . , 18ₙ, associated with user account 24 to CLIENT 26. In the cases where the server stores (or has access to) the network passwords, they may be provided directly, otherwise, the secret keys 16₁, 16₂. . . , 16ₙ, will need to be processed according to function 20 (e.g., as implemented by dedicated circuitry at sever 22 or a processing element of server 22 executing appropriate instructions) to derive the network passwords, which can then be provided to CLIENT 26. CLIENT 26 stores this information (e.g., in on-board memory or in an associated removable storage device) for later use.

Once the CLIENT 26 has the MAC address(es) (or other identifiers) 14₁, 14₂, . . . , 14ₙ, and network passwords 18₁, 18₂, . . . , 18ₙ stored, the CLIENT 26 can join WLAN 30, which includes an AP hosted by AP hosting device 12. For example, the MAC address (or other identifier) 14 may serve as a BSSID (basic service set identifier) for WLAN 30, while the network password 18 serves as the PSK for same. Upon observing one of the stored BSSIDs broadcast by AP hosting device 12, the CLIENT may join WLAN 30 in the conventional fashion, either automatically or by prompting the user of the CLIENT to express the user's assent to joining the network.

In order to avoid situations in which the configuration values (i.e., the MAC address (or other identifier) 14 and the secret key 16) known to server 22 no longer match those set in the AP hosting device 12 itself, the AP hosting device may be configured to prevent user-initiated changes of certain values, or may attempt to propagate such changes to the server 22, allowing future provisioning attempts to succeed. This may be done, for example, through one or more wireless and/or wired networks of which the server 22 and AP hosting device 12 are a part (not shown in this illustration).

Alternative implementations of the above-described scheme are also possible. For example, in embodiments where advanced security protocols, such as WPA, are not in use, or in cases where association to the network and/or network resources need not be protected, or are protected at other protocol layers, the present provisioning system may permit CLIENT 26 to obtain any observed (e.g., over the air) BSSID and/or SSID of an Al' it wishes to join, use the OOB network to query the server 22, providing AP-identifying information as necessary, and receive the SSID and/or PSK value for the observed network in return. The CLIENT can then securely connect to the observed AP, in a user-assisted (e.g., “approve this connection” or “please enter this key when prompted”) or completely automatic manner.

Thus, methods and systems for out-of-band delivery of wireless network credentials to a device have been described. In any of the embodiments described herein, the information concerning the subject AP hosting device and/or WLAN may be provided to the client device in response to a request therefor, or may be pushed to the client device. Alternatively, the information may be provided upon a successful log in to a user account without a user having to make a separate request therefor. Such a log in may be initiated upon successful installation of an application to a smart phone or similar device and provisioning of the application with the user account credentials. Alternatively, or in addition, the log in may be initiated in response to a user action, such as an indication for the log in process to be initiated via the smart phone application or other means. In addition to information concerning the subject WLAN, the server may provide information concerning other AP hosting devices and/or respective WLANs associated with the user account.

What is claimed is:

1. A method, comprising:
at a server, associating a user account established by a user of an access point (AP) hosting device with information sufficient to permit a client device to join a wireless local area network (WLAN) of which an AP hosted by the AP hosting device is a part; and
providing, upon receipt of user account credentials and via an out of band (OOB) network different from the WLAN, the client device with the information sufficient to permit the client device to join the WLAN of which the AP is a part.

2. The method of claim 1, wherein the information sufficient to permit the client device to join the WLAN of which the AP is a part comprises a unique identifier for the AP hosting device and information indicative of a network key for the WLAN.

3. The method of claim 2, wherein the unique identifier for the AP hosting device comprises a media access control (MAC) address of the AP hosting device.

4. The method of claim 3, wherein the information indicative of a network key for the WLAN comprises a secret key associated with the AP hosting device.

5. The method of claim 3, wherein the information indicative of a network key for the WLAN comprises the network key for the WLAN.

6. The method of claim 3, wherein the information indicative of a network key for the WLAN comprises information that permits generation of the network key for the WLAN.

7. A system, comprising:
a server configured to associate a user account established by a user of an access point (AP) hosting device with information sufficient to permit a client device to join a wireless local area network (WLAN) of which an AP hosted by the AP hosting device is a part; and to provide the client device via an out of band (OOB) network different from the WLAN the information sufficient to permit the client device to join the WLAN of which the AP is a part; and
the AP hosting device configured to establish the WLAN with configuration parameters that accommodate the use of the information sufficient to permit the client device to join the WLAN of which the AP is a part.

8. The system of claim 7, wherein the information sufficient to permit the client device to join the WLAN of which the AP is a part comprises a unique identifier for the AP hosting device and information indicative of a network key for the WLAN.

9. The system of claim 8, wherein the unique identifier for the AP hosting device comprises a media access control (MAC) address of the AP hosting device.

10. The system of claim 9, wherein the information indicative of a network key for the WLAN comprises a secret key associated with the AP hosting device.

11. The system of claim 8, wherein the information indicative of a network key for the WLAN comprises the network key for the WLAN.

12. The system of claim 8, wherein the information indicative of a network key for the WLAN comprises information that permits generation of the network key for the WLAN.

13. A method, comprising:
establishing at a server, a user account, said user account having user account credentials and being associated with information sufficient to permit a client device to join a wireless local area network (WLAN) of which an access point (AP) is a part;
upon receiving the user account credentials, providing the client device, via an out of band (OOB) network different from the WLAN, the information sufficient to permit the client device to join the WLAN of which the AP is a part; and
the client device joining the WLAN according to configuration parameters based on the information sufficient to permit the client device to join the WLAN of which the AP is a part.

14. The method of claim 13, wherein the information sufficient to permit the client device to join the WLAN of which the AP is a part comprises information that permits generation of a network key for the WLAN.

15. The method of claim 13, wherein the information sufficient to permit the client device to join the WLAN of which the AP is a part comprises a unique identifier for an AP hosting device and information indicative of a network key for the WLAN.

16. The method of claim 15, wherein the unique identifier for the AP hosting device comprises a media access control (MAC) address of the AP hosting device.

17. The method of claim 16, wherein the information indicative of a network key for the WLAN comprises a secret key associated with the AP hosting device.

18. The method of claim 16, wherein the information indicative of a network key for the WLAN comprises the network key for the WLAN.
